(19) United States
(12) Patent Application Publication
(10) Pub. No.: US 2024/0143288 A1
(43) Pub. Date: May 2, 2024

(54) INTELLIGENT CODE EDITOR

(71) Applicant: INTERNATIONAL BUSINESS MACHINES CORPORATION, ARMONK, NY (US)

(72) Inventors: Priya Kalra, Delhi (IN); Vivek Warrier, Bengaluru (IN); Anita Duggal, Delhi (IN); Mukundan Sundararajan, Bangalore (IN)

(21) Appl. No.: 18/049,646

(22) Filed: Oct. 26, 2022

(51) Int. Cl. G06F 8/33

(52) U.S. Cl. CPC G06F 8/33

(57) ABSTRACT

Described are techniques for an intelligent code editor that intelligently provides software development suggestions based on the coding techniques of a software developer. The techniques include analyzing source code samples associated with a software developer to determine coding techniques utilized by the software developer. The techniques further include monitoring code editing input received by an intelligent code editor to identify a software design pattern, where the code editing input is associated with the software developer. The techniques further include generating a suggested software design pattern that is based on the software design pattern identified in the code editing input and the coding techniques of the software developer, and displaying the suggested software design pattern in the intelligent code editor to allow the suggested software design pattern to be incorporated into the code editing input using the intelligent code editor.

### BACKGROUND

The present disclosure relates to source-code editors, and, more specifically, to an intelligent code editor that provides suggested software design patterns that correspond to the coding techniques of a software developer.

Software development is the process of designing and programming applications, frameworks, and other software components. Software development involves writing and maintaining source code using a source-code editor. A source-code editor is a text editor program designed specifically for editing source code of computer programs. A source-code editor may be a standalone application or it may be built into an integrated development environment (IDE) or web browser. Source-code editors are a fundamental programming tool used by software developers to write and edit source code.

### SUMMARY

Aspects of the present disclosure are directed toward a computer-implemented method comprising analyzing source code samples associated with a software developer to determine coding techniques utilized by the software developer. The computer-implemented method further comprising monitoring code editing input received by an intelligent code editor to identify a software design pattern, where the code editing input is associated with the software developer. The computer-implemented method further comprising generating a suggested software design pattern that is based on the software design pattern identified in the code editing input and the coding techniques of the software developer and displaying the suggested software design pattern in the intelligent code editor to allow the suggested software design pattern to be incorporated into the code editing input using the intelligent code editor.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example computing environment implementing an intelligent code editor, in accordance with some embodiments of the present disclosure.

FIG. 2 is a diagram that illustrates an example of a user interface of an intelligent code editor for selecting suggested software design patterns, in accordance with some embodiments of the present disclosure.

FIG. 3 is a diagram illustrating an example of a shared development environment that is accessible by way of an intelligent code editor, in accordance with some embodiments of the present disclosure.

FIG. 4 is a flow diagram illustrating an example operational flow of an intelligent code editor system, in accordance with some embodiments of the present disclosure.

FIG. 5 is a flow diagram illustrating an example method for generating suggested software design patterns based on the coding techniques of a user, in accordance with some embodiments of the present disclosure.

FIG. 6 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward an intelligent code editor that intelligently provides software development suggestions based on the coding techniques of a software developer. While not limited to such applications, embodiments of the present disclosure may be better understood in light of the aforementioned context.

In software engineering, a software design pattern (also referred to as a code pattern) is a general, reusable solution to a commonly occurring problem within a given context in software design. The software design pattern is not a finished design that can be transformed directly into source or machine code. Rather, the software design pattern is a description or template for how to solve a problem that can be used in many different situations. Software design patterns are formalized best practices that a software developer can use to solve common problems when designing an application or system. These software design patterns can assist the development process by providing tested, proven development paradigms. For example, effective software development requires considering issues that may not become apparent until later during implementation of the software. Untested source code can often contain hidden subtle issues that take time to be detected, and can sometimes cause problems after implementation. Reuse of software design patterns can prevent these subtle issues, and can also improve code readability for software developers and architects who are familiar with the software design patterns.

Commonly, source-code editors for developing applications and programs provide suggestion features to assist software developers. For example, a source-code editor may provide syntax highlighting, indentation, autocomplete, and brace matching functionality. However, the suggestion features of prior source-code editors have not addressed challenges faced by many of today's software developers. As an example, prior source-code editors do not provide software design pattern suggestions to software developers. Rather, in the past, software developers have had to look to other resources, such as programming books, tutorials, and the like to find software design pattern documentation. Moreover, after finding the software design pattern documentation for a particular problem, the software developer then had to modify the software design pattern to correspond to the developer's own coding techniques.

Advantageously, aspects of the present disclosure overcome these challenges. More specifically, aspects of the present disclosure provide software developers with an intelligent code editor that provides suggested software design patterns that correspond to individual software developer techniques and system requirements. For example, aspects of the present disclosure analyze source code samples associated with an individual software developer to determine coding techniques utilized by the software developer. Aspects of the present disclosure then monitor input entered by the software developer into a user interface of the intelligent code editor and determine that the input correlates to a software design pattern. In response to determining that the software developer is working on the identified software design pattern, aspects of the present disclosure modify the software design pattern to correspond to the software developer's coding techniques and suggest the modified software design pattern to the software developer by displaying the modified software design pattern in the user interface of the intelligent code editor. This allows the software developer to accept the suggestion and populate the modified software design pattern into the software developer's source code using the intelligent code editor.

Accordingly, aspects of the present disclosure improve upon prior source-code editors, which are a type of user interface, by generating a personalized software design pattern suggestion and displaying the software design pattern suggestion in the user interface of the intelligent code editor to allow the software developer to incorporate the software design pattern suggestion into the software developer's source code. Accordingly, the present disclosure describes a structured user interface of an intelligent code editor paired with software development functionality that is directly related to the user interface's structure that resolves problems of prior source-code editors.

Prior source-code editors do not provide collaborative development environments that allow software developers to securely work together to understand, modify, and/or improve software code designs. Aspects of the present disclosure overcome this challenge by providing software developers with a shared development environment that is accessed through the intelligent code editor. The shared development environment enables a software developer to obtain assistance from other software developers and collaboratively develop software design patterns via the intelligent code editor. More specifically, aspects of the present disclosure can receive an assistance request from a software developer via the intelligent code editor. The assistance request asks other software developers for help in understanding and/or modifying a software design pattern. In response to receiving an assistance request, aspects of the present disclosure can create a shared development environment that is accessible to the other software developers via a collaborative development portal and an instance of the intelligent code editor. The other software developers can then access the shared development environment via respective instances of the intelligent code editor and provide the assistance requested. Accordingly, aspects of the present disclosure improve upon prior source-code editors by providing a means to access a shared development environment and obtain assistance in understanding and developing software design patterns. Other advantages of the present disclosure not specifically described above will become clear in the discussion below.

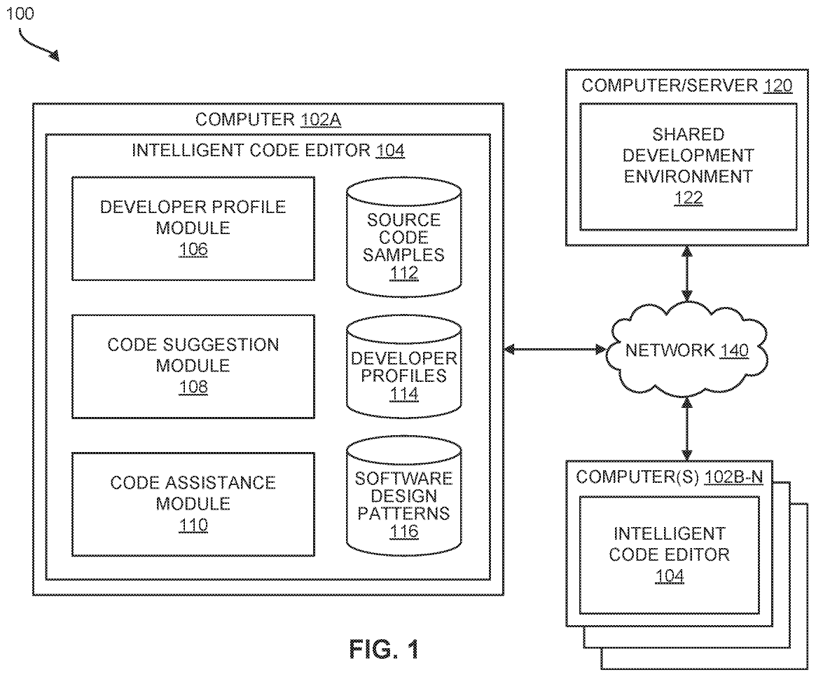

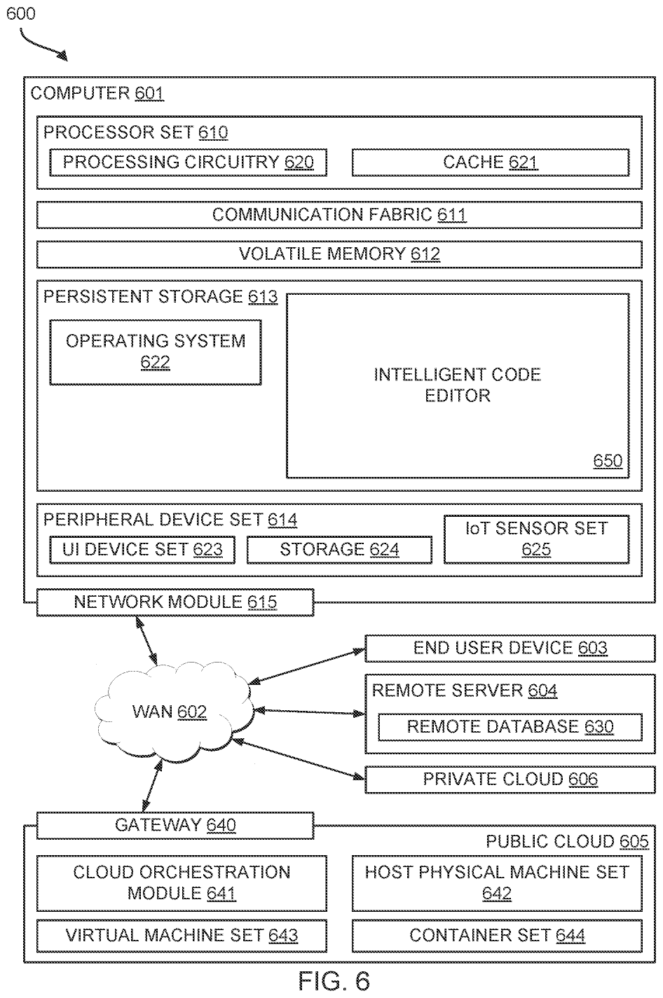

Referring now to the figures, FIG. 1 illustrates a block diagram of an example computing environment 100 that implements an intelligent code editor 104 configured to provide software design pattern suggestions, in accordance with some embodiments of the present disclosure. The computing environment 100 and the intelligent code editor 104 shown and discussed in relation to FIG. 1 correspond to the examples of the computing environment 600 and intelligent code editor 650 shown and discussed in reference to FIG. 6.

As illustrated, instances of the intelligent code editor 104 can be hosted on computers 102A, 102B, and 102N (where N represents any number of computers 102). The intelligent code editor 104 provides a user (e.g., a software developer, programmer, coder, etc.) with a software development environment used to develop and/or maintain source code for a program or application. The computers 102A-N, in some examples, can be virtual machines (VMs) hosted in a private or public cloud environment as described later in association with FIG. 6.

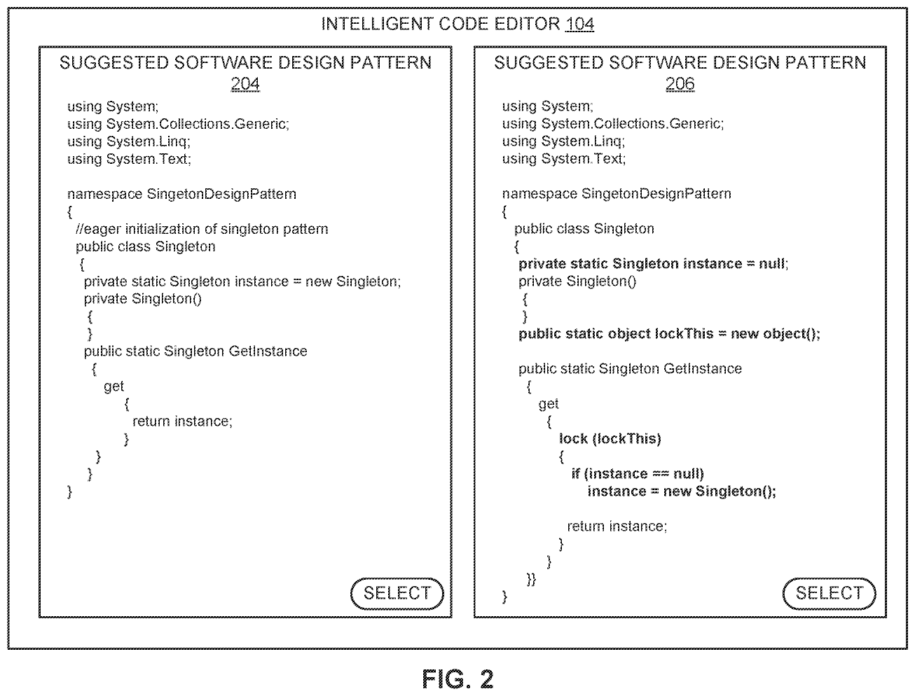

The intelligent code editor 104 comprises a text editor program having a user interface for creating and editing source code, and software developer tools that provide user-assistance for developing software products. In some embodiments, the intelligent code editor 104 is part of an integrated development environment (IDE) which can also include build automation tools, a compiler or interpreter, and a debugger. Also, in some embodiments, the intelligent code editor 104 comprises a web application that executes in a web browser application. The intelligent code editor 104 uses artificial intelligence (AI) and algorithms to analyze software design patterns based on a user's coding techniques and generates suggested software design patterns which the user can populate into the source code of a software product. A non-limiting example of a suggested software design pattern is shown in FIG. 2. As part of generating a suggested software design pattern, the intelligent code editor 104 can identify system requirements (e.g., naming conventions, memory usage, etc.) and modify the software design pattern based on the system requirements, thereby avoiding compile and/or runtime errors. The intelligent code editor 104 can be generic (e.g., not based on any single programming or scripting language) to provide learning and coding support in any programming language or natural language to enable users to learn and understand various programming concepts more quickly.

The intelligent code editor 104 includes a number of modules that provide the software developer tools used to develop software products. In the embodiment shown in FIG. 1, the intelligent code editor 104 includes a developer profile module 106, a code suggestion module 108, a code assistance module 110, and other modules as can be appreciated. The developer profile module 106 analyzes source code samples 112 associated with a user to identify coding techniques utilized by a user to write software programs and generates a developer profile 114 that specifies the coding techniques used by the user. The coding techniques of the user can include, but are not limited to, a commonly utilized programming or coding style, software design patterns, software libraries, programming and/or scripting languages, representation of mathematics and logical rules, function call signatures, variable usage and memory management, as well as other user coding techniques as will be appreciated.

As an example, the developer profile module 106 analyzes source code samples 112 associated with a user (e.g., prior software projects) to identify a programming style used by the user. A programming style is a set of rules or guidelines used to write source code for a computer program. A programming style used in a particular software program may be derived from the coding conventions of a company or other computing organization, as well as the preferences of the user. Elements of a programming style can include: the layout of source code, including indentation; the use of white space around operators and keywords; capitalization or otherwise of keywords and variable names; the style and spelling of defined identifiers, such as a function, a procedure and variable names; and the use and style of comments. Some programming styles can be applied to many different programming languages, whereas other programming styles are designed for a specific programming language (e.g., a programming style designed for the C programming language may not be appropriate for another programming language, such as the BASIC programming language). Accordingly, the developer profile module 106 identifies a general programming style used by a user, as well as specific programming styles used for specific programing languages, and includes this information in the user's developer profile 114.

Continuing the example above, the developer profile module 106 also analyzes the source code samples 112 to identify software design patterns commonly utilized by the user. As indicated earlier, a software design pattern is a structured approach to computer programming that is intermediate between the levels of a programming paradigm and a concrete algorithm (not a finished design that can be transformed directly into source or machine code), thereby providing a framework for a reusable solution to a commonly occurring problem within a given context in software design. Examples of software design patterns include user interface design patterns, information visualization, secure design, web design, business model design, and other domain-specific patterns. The developer profile module 106 can parse the source code samples 112 associated with the user to identify a framework of a software design pattern and include information for the software design pattern in the user's developer profile 114. The developer profile module 106 can also analyze the source code samples 112 to identify a programming language commonly used by the user, software libraries commonly used by the user, as well as other coding techniques commonly used by the user, and include this information in the user's developer profile 114.

In some embodiments, the developer profile module 106 can use an AI model trained to identify a user's coding techniques in source code. The AI model learns the user's coding techniques from analysis of the source code samples 112. For example, the AI model analyzes the source code samples 112 to: determine a combination of named entities and keywords/reserved words with symbols (e.g., primitive data type) in the source code samples 112, determine how the functionality (logical/mathematical) relationships between the keywords and named entities are implemented, and then determine how specific software design patterns are typically incorporated as code group statements which comprise the user's coding techniques.

The code suggestion module 108 generates one or more suggested software design patterns that correspond to a user's coding techniques as specified in the user's developer profile 114 and provides the one or more suggested software design patterns in the user interface of the intelligent code editor 104 (e.g., pop-up dialog, pop-up window, split editor window, etc.) to allow the user to incorporate the suggested software design pattern into the user's source code. Illustratively, generating a suggested software design pattern to correspond to a user's coding techniques can include obtaining a user's developer profile 114 and determining one or more parameters based on the user's developer profile 114, such as software design patterns typically utilized by the user, determining a programming language typically used by the user, determining a programming style of the user, and generating the suggested software design pattern based on the one or more parameters.

A suggested software design pattern generated by the code suggestion module 108 comprises a source code statement or programming statement that is based on the framework of a software design pattern and corresponds to the coding techniques of the user, as well as the system requirements of a respective software program (e.g., hardware and software operating requirements). The source code statement comprises computer code that implements the structure of the software design pattern using the coding techniques of the user as specified in the user's developer profile 114. Alternatively, in other embodiments, a suggested software design pattern generated by the code suggestion module 108 comprises pseudocode or abstracted code that outlines the framework of a software design pattern in an informal language that corresponds to the programming style of a user as specified in the user's developer profile 114.

In some embodiments, an AI model generates the suggested software design patterns. The AI model predicts the user's coding style and a software design pattern that is optimized to the user's design requirements. The AI model can generate the software design pattern based on a test case flow that corresponds to the user's design requirements. For example, the AI model can: analyze a code block that the user is currently working on to determine mathematical, logical, functional flow of the code (e.g., APIs, services, library statements, etc. being called in the code); create a natural language sentence(s) by mapping variable names to nouns found in the design requirements (which are typically found in code comments with the operations becoming verbs). The sentence(s) can comprise a portion of a software design pattern, which can be compared to existing software design patterns for which the AI model has been trained on. If the AI model determines that the sentence(s) corresponds to an existing software design pattern, the AI model generates one or more suggested software design patterns based on the existing software design pattern and the user's coding style or technique. However, if there are no existing software design patterns that correspond to the sentence(s), then the AI model can identify the sentence(s) as a new software design pattern, which can be suggested to the user during development of future software projects.

Because there may be multiple ways to implement a software design pattern, in some embodiments, the code suggestion module 108 can generate multiple implementations of a suggested software design pattern from which a user can choose from. For example, referring generally to FIG. 1 and FIG. 2, the code suggestion module 108 can generate a first implementation of a suggested software design pattern 204 (e.g., a less secure implementation), and a second implementation of the suggested software design pattern 206 (e.g., a more secure implementation that avoids thread lock). Both suggested software design patterns 204 and 206 can be presented in the user interface of the intelligent code editor 104 to allow a user to select one of the suggested software design patterns 204 or 206 for integration into the user's source code. In other embodiments, the code suggestion module 108 identifies an optimal implementation of a software design pattern (e.g., based on a system requirement, such as a security requirement) and presents the suggested software design pattern to the user.

In some embodiments, the code suggestion module 108 generates test cases based on a software design pattern selected by a user. The test cases provide the user with performance information that allows the user to select an optimal software design pattern for a software program. Generally, a test case details what to test, testing procedures, and expected results of the test. The test cases can be designed in a functionality flow of a finally designed system, which enables a user to more efficiently identify which software design pattern to use for functionality implementation, perform unit testing, and obtain a peer review. Accordingly, designing the system using the suggested software design pattern and test cases to test and review the system is expected to produce the least probability of failure.

Referring again to FIG. 1, the intelligent code editor 104 can use various methods to provide suggested software design patterns to users. As an example, in some embodiments the intelligent code editor 104 (via the code suggestion module 108) monitors code editing input for source code that resembles a software design pattern. In response to identifying code editing input that resembles a software design pattern, the code suggestion module 108 generates one or more suggested software design patterns to correspond to the coding techniques of the user and the system requirement of the software program. Code editing input monitored by the intelligent code editor 104 can include both source code which is input to the intelligent code editor 104 using an input device (e.g., keyboard), and source code loaded into the intelligent code editor 104 from a source code file. As an example, as code editing input is received into the user interface of the intelligent code editor 104, the code suggestion module 108 analyzes the code editing input to determine whether the code editing input resembles a known software design pattern 116. The code suggestion module 108 then compares the code editing input to a collection of software design patterns 116 (e.g., using an AI model) to determine whether the code editing input resembles a software design pattern 116 included in the collection. The code editing input can comprise a portion of a source code statement (e.g., an incomplete or partial source code statement), and the code suggestion module 108 can match the portion of the source code statement to a portion of a software design pattern 116 included in the collection of software design patterns.

In the event that the code editing input resembles a software design pattern 116, the code suggestion module 108 generates one or more suggested software design patterns that are based on the software design pattern 116 and correspond to the user's coding techniques, as well as system requirements of the respective software program being developed. The one or more suggested software design patterns are provided in the user interface of the intelligent code editor 104 (e.g., via a pop-up dialog, pop-up window, split editor window, or the like) to allow the user to accept a suggested software design pattern and incorporate the suggested software design pattern into the user's source code. In some embodiments, the suggested software design patterns are displayed in the user interface of the intelligent code editor 104 so as to not obscure a workspace containing source code that the user is working on (e.g., in a source code split window where a first window contains the user's source code and a second window contains a suggested software design pattern). In some embodiments, a user can be presented with a preview of a suggested software design pattern integrated into the user's source code. In some embodiments, the code suggestion module 108 can populate a suggested software design pattern into the user's source code using an autofill or auto replace tool in response to the user selecting the suggested software design pattern.

As another example, in some embodiments the intelligent code editor 104 provides a code review tool (not shown) that analyzes code editing input loaded from a file into the intelligent code editor 104 to identify software design patterns and provide one or more suggested software design patterns that improve performance of a respective software program. The code review tool is provided by the code suggestion module 108, which analyzes a user's source code (e.g., loaded into the intelligent code editor 104 from a file) and identifies an existing software design pattern in the source code. In response to identifying a software design pattern in the user's source code, the code suggestion module 108 generates one or more suggested software design patterns that may be a better fit for the user's software program. The suggested software design pattern(s) generated by the code suggestion module 108 may be more qualitative in terms of performance and/or number of lines of computer code. The code suggestion module 108 provides the one or more suggested software design patterns in the user interface of the intelligent code editor 104 (e.g., via a pop-up dialog, pop-up window, or the like) to allow the user to accept a suggested software design pattern and incorporate the suggested software design pattern into the user's source code. In some embodiments, the code suggestion module 108 populates the suggested software design pattern into the user's source code using an auto replace tool that overwrites an existing software design pattern with the suggested software design pattern.

As another example, in some embodiments, the source code editor 104 provides a search tool that allows a user to search for software design patterns for use in the user's source code, thereby potentially decreasing the development time of the user's software program. The search tool is provided by the code suggestion module 108, which performs searches for software design patterns 116 using search parameters specified by the user. Illustratively, the search parameters can include a design pattern domain (e.g., user interface, information visualization, secure design, web design, etc.), system requirements (e.g., hardware and software requirements), programming or scripting language, and other search parameters, as can be appreciated. In some embodiments, the code suggestion module 108 is capable of performing a natural language search for suggested software design patterns, such that a user can request a search using conversational phrases to specify the search parameters. In response to receiving a search request for a suggested software design pattern, the code suggestion module 108 queries a collection (data store) of software design patterns 116 for one or more software design patterns 116 that correspond to the search parameters and returns the search results to the user. The search results can include documentation and/or tutorials for the software design patterns 116. The user can review the search results (including viewing documentation and tutorials) and select a software design pattern 116 for the user's project. In response, the code suggestion module 108 generates a suggested software design pattern that is based on the structure of the software design pattern 116 and the user's coding techniques specified in the user's developer profile 114, as well as any system requirements. The code suggestion module 108 then provides the suggested software design pattern in the user interface of the intelligent code editor 104 (e.g., via a pop-up dialog, pop-up window, or the like) to allow the user to include the suggested software design pattern the user's source code. As in other embodiments, the code suggestion module 108 can populate the suggested software design pattern into the user's source code using an autofill tool that inserts the suggested software design pattern into the user's source code.

In some embodiments, the intelligent code editor 104 can be configured to connect a user to a shared development environment 122 that allows the user to collaborate with other software developers. Illustratively, the shared development environment 122 can provide a secure collaboration space for software developers to experiment and build new coding styles to fit an industry, business, or process component. The shared development environment 122 enables group-based development, based on multiple coding styles or development methodologies (e.g., extreme programming, pair programming, test driven etc.), to generate optimal code and resolve complex use cases. In some embodiments, the shared development environment 122 is a secure instance of a software development environment (e.g., integrated development environment (IDE)) that includes tools for developing software products. The intelligent code editor 104 connects users to the shared development environment 122 via the code assistance module 110 and a collaborative development portal (portal address). As an example, a user who wishes to obtain assistance and/or collaborate with other software developers can request a shared development environment 122 by submitting a request to the code assistance module 110 (e.g., via a menu command in the user interface of the intelligent code editor 104). The request can include parameters, such as identification information for software developers who are authorized to join the collaborative session in the shared development environment 122 (e.g., usernames, group name, security profile(s), etc.); shared code specifications (e.g., share all source code or share a portion of source code); code abstraction level specifications (e.g., fully abstract code, partially abstract code, or share original code), shared environment variables specifying a particular programming language or pseudo code, developer tool specifications, communication tool specifications, etc.; as well as other parameters that can be applied to the shared development environment 122.

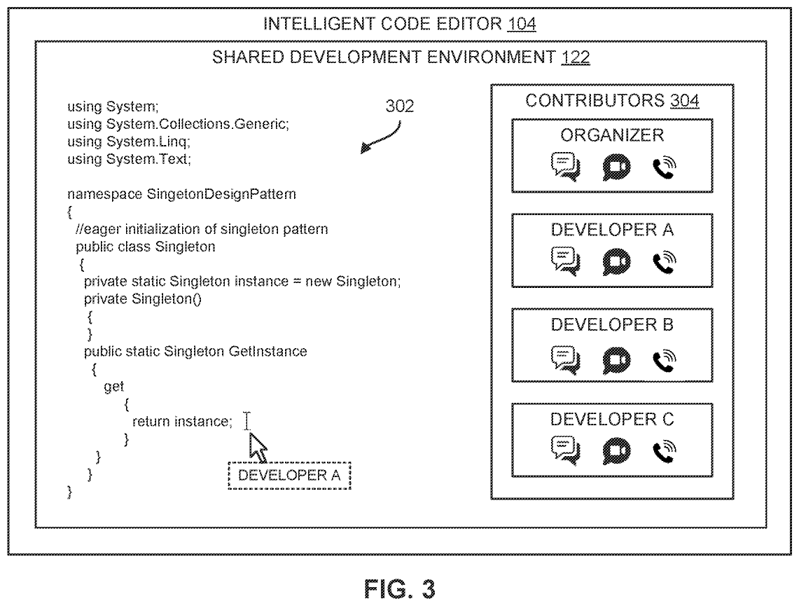

In response to a request to launch a shared development environment 122, the code assistance module 110 determines who will have access to the shared development environment 122 and a configuration of the shared development environment 122 using the parameters included in the request. For example, referring generally to FIG. 1 and FIG. 3, the secure shared development environment 122 can be configured to allow access to only authorized software developers (contributors 304). The code assistance module 110 references the request parameters to determine which software developers are authorized to join the collaborative session and sends invitations to the software developers using an appropriate communication method (e.g., email, calendar request, text message, and the like). As an example, the request parameters can specify specific software developers (e.g., via a company directory, usernames, email addresses, phone numbers, etc.) who the user (organizer) would like to invite to the collaborative session, and the code assistance module 110 can send invitations to the software developers. As another example, the request parameters can specify a software developer group (e.g., team group name) and the code assistance module 110 can determine who is included in the software developer group and send invitations to the members of the software developer group. As another example, the request parameters can specify a skill or knowledge base requirement for contributors 304 (e.g., a programming certification or a system certification) and the code assistance module 110 can perform a search for software developers who have the skill or knowledge base and send invitations to the software developers. In some embodiments, the code assistance module 110 can provide a scheduling tool that allows contributors 304 to accept or decline an invitation to join a collaborative session at a designated time, and/or suggest a different time for the collaborative session. The code assistance module 110 configures the shared development environment 122 according to the request parameters and launches the shared development environment 122 (e.g., on demand or at a scheduled time) on a computer/server 120.

In some embodiments, an organizer of a collaborative session can grant other contributors 304 the ability to directly edit shared code 302 in the shared development environment 122 (e.g., allow developer A to edit the shared code 302 as shown in FIG. 3). Also, in some embodiments, the shared development environment 122 can provide an anonymous feature that allows contributors 304 to hide their identity (e.g., personal name, username, etc.). As an example, contributors 304 shown in the shared development environment 122 can be assigned generic identities (e.g., developer A, developer B, and the like) that mask the real identities (e.g., personally identifying information) of the contributors 304. The shared development environment 122 can enable various communication methods between contributors 304, including text messaging, videoconferencing, and teleconferencing. Communication can be established between any two or more of the contributors 304 using one of the communication methods, allowing the contributors 304 to collaborate by providing explanations, sharing examples, and discussing issues.

As illustrated in FIG. 1, the shared development environment 122 can be hosted on a computer/server 120 accessible to computers 102A, 102B, and 102N over a network 140. The computer/server 120, in some embodiments, can be located in a public or private cloud environment, as described in association with FIG. 6. Alternatively, in some embodiments, the shared development environment 122 can be hosted on the user's computer (e.g., computer 102A) and computers 102B and 102N can connect to the user's computer via a collaborative development portal.

In some embodiments, the modules illustrated and described above can be implemented as computing services hosted in a cloud environment (e.g., clouds 606 or 605 in FIG. 6). For example, a module can be considered a service with one or more processes executing on a server or other computer hardware. Such services can provide a service application that receives requests and provides output to other services or consumer devices. An application programming interface (API) can be provided for each module to enable a first module to send requests to and receive output from a second module. Such APIs can also allow third parties to interface with the module and make requests and receive output from the modules.

FIG. 1 illustrates that a network 140 is provided to enable communication between the components of the computing environment 100. The network 140 can include any useful computing network, including an intranet, the Internet, a local area network, a wide area network, a wireless data network, or any other such network or combination thereof. Components utilized for the network 140 can depend at least in part upon the type of network and/or environment selected. Communication over the network 140 can be enabled by wired or wireless connections and combinations thereof. While FIG. 1 illustrates an example of a computing environment that can implement the techniques above, many other similar or different environments are possible. The example environments discussed and illustrated above are merely representative and not limiting.

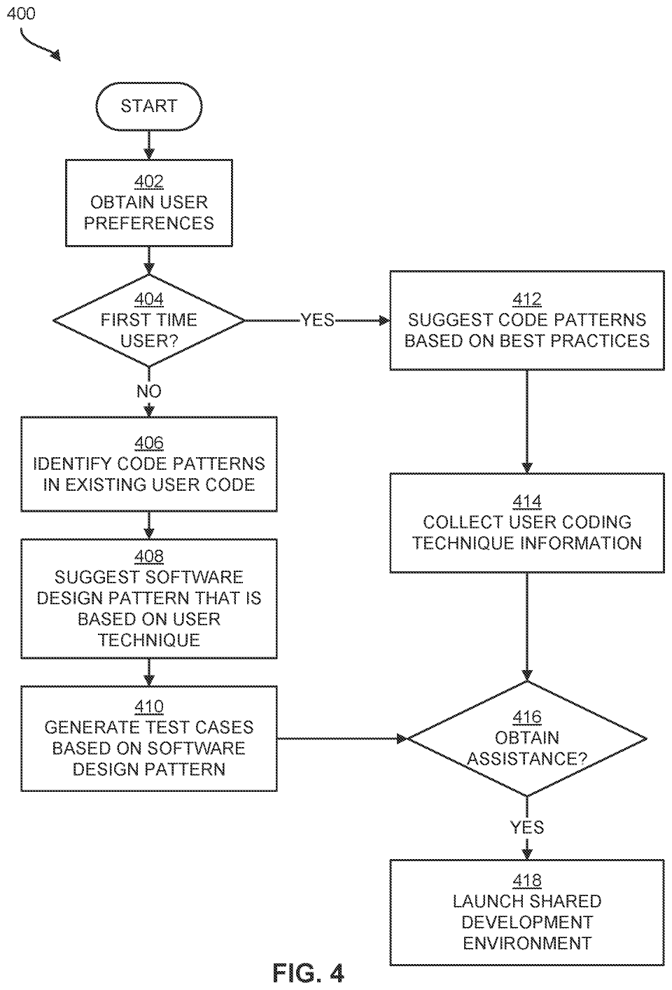

FIG. 4 is a diagram that illustrates an example operational flow 400 of an intelligent code editor system (“system”), in accordance with some embodiments of the present disclosure. Starting with operation 402, as part of starting the intelligent code editor, a user is asked to provide configuration preferences for the system, such as preferred programming language, preferred platform experiences, etc., as well as user identifier information that can be used to associate existing software projects with the user.

As in operation 404, the system determines whether the user is a first-time user of the intelligent code editor. Determining whether a user is a first-time user or an existing user can include determining whether the user has a developer profile (e.g., the developer profile 114 described in FIG. 1). In the case that the user is an existing user, then the system obtains the developer profile for the user, which provides the system access to the user's information, including the user's source code for software programs previously developed by the user.

As in operation 406, the system analyzes the existing source code to identify software design patterns that the user followed to implement functionality in the software programs. This information provides the system with commonly used software design patterns, as well as coding techniques utilized by the user to implement the software design patterns, such as the user's programming or coding style, programming and/or scripting languages, representation of mathematics and logical rules, function call signatures, variable usage and memory management, and other user coding techniques as will be appreciated.

As in operation 408, after obtaining the information above, the system suggests software design patterns that are based on the user's coding techniques. As an example, the system can generate a source code statement that is based on the framework of the software design pattern and the programming style of the user. As another example, the system can generate pseudocode or abstracted code that outlines the framework of the software design pattern in an informal language that corresponds to the programming style of a user. In some embodiments, an AI model generates the suggested software design patterns.

As in operation 410, the system generates one or more test cases that are based on a software design pattern selected by the user. The test cases provide the user with performance information that allows the user to select an optimal software design pattern for a software program. Generally, a test case details what to test, testing procedures, and expected results of the test. The test cases can be designed in a functionality flow of a final system design, which enables the user to more efficiently identify a software design pattern that is best for implementing functionality in the software program.

Returning to operation 404, in the case that a user is a first-time user of the system, there is no existing source code associated with the user that the system can analyze. Therefore, as in operation 412, the system suggests software design patterns that are based on best practices, as well as generates test cases that are based on a software design pattern selected by the user and a functionality flow of the user's system design. As in operation 414, the system collects coding technique information for the first-time user so that over time the system can learn the user's preferences and suggest software design patterns that correspond to the user's coding techniques.

As in operation 416, the system can provide development assistance to a user by way of other software developers who may be willing to answer questions, provide examples, and/or collaborate on a software project. The system can connect the user and other software developer(s) using a variety of assistance formats, including messaging, videoconferencing, and/or teleconferencing. In cases where the user requests assistance from other software developers, the system, as in operation 418, connects the user to a shared development environment via a collaborative development portal (portal address), as described earlier in association with FIG. 1 and FIG. 3. Inside the shared development environment, the user's original source code can be hidden from other software developers and only the software design pattern or partial binary may be visible to the other software developers. As an example, the user's source code can be shared using a code abstraction style, such that there is no need to show the original code (e.g., original source code or software design pattern) in the shared development environment. Instead, shared code can comprise just a section of the original code or pseudo code to allow discussion among the software developers without showcasing the original code, thereby safeguarding the original code. Also, the identities of the software developers (including the user) can be hidden in order to provide anonymity to the software developers.

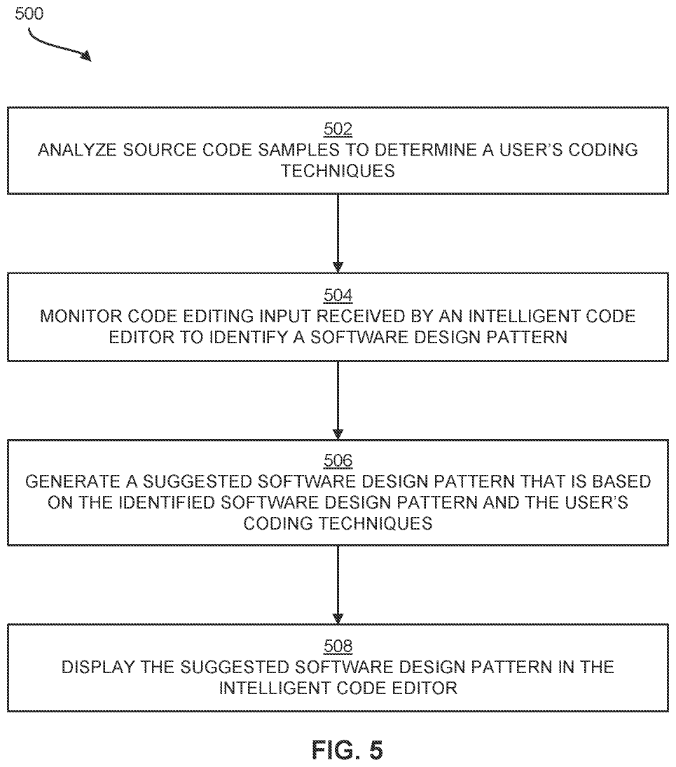

Moving now to FIG. 5, illustrated is a flow diagram of an example method 500 for generating suggested software design patterns based on the coding techniques of a user, in accordance with some embodiments of the present disclosure. Starting with operation 502, source code samples associated with a software developer are analyzed to determine coding techniques utilized by the software developer. For example, the source code samples can be obtained from existing software projects associated with the software developer (e.g., from a code repository), and the source code samples can be analyzed to identify coding techniques that include: software design patterns followed by the software developer to implement functionality in software programs, a programming style used by the software developer (e.g., a set of rules or guidelines used to write source code), as well as programming and scripting languages, software libraries, representations of mathematics and logical rules, function call signatures, variable usage, and memory management techniques used by the software developer. In some embodiments, source code samples are analyzed using a first AI model that has been trained to identify coding techniques utilized by a software developer.

After deriving the coding techniques of the software developer from the source code samples, operation 504 monitors code editing input for source code that resembles a software design pattern. The code editing input includes source code that is input to the intelligent code editor using an input device (e.g., keyboard), as well as source code that is loaded into the user interface of the intelligent code editor from a source code file. In some embodiments, the code editing input is monitored using a second AI model that has been trained to identify software design patterns in code editing input.

In some embodiments, as code editing input is received into the user interface of the intelligent code editor, the code editing input is analyzed to determine whether the code editing input resembles a known software design pattern. As an example, the code editing input can be compared to software design patterns stored in a data store (e.g., using the second AI model) to determine whether the code editing input corresponds to a software design pattern in the data store. In some embodiments, a software design pattern can be identified using a portion or fragment of the software design pattern. For example, code editing input can comprise a portion of a source code statement (e.g., a fragment or partial source code statement), and the code editing input can be matched to a portion of a software design pattern in the data store.

In some embodiments, code editing input loaded into the code editor from a source code file can be analyzed to identify an existing software design pattern in the source code, and the method 500 provides one or more suggested software design patterns that may improve upon the existing software design pattern. The suggested software design pattern(s) may be more qualitative in terms of performance and/or number of lines of computer code as compared to the existing software design pattern.

Operation 506 generates one or more suggested software design patterns that are based on the software design pattern identified in the code editing input and the coding techniques of the software developer. The one or more suggested software design patterns can also be generated to adhere to the system requirements of a software program (e.g., hardware and software operating requirements). As an example, the method 500 can generate a source code statement that is based on the framework of a software design pattern identified in the code editing input and the programming style of the software developer. As another example, the method 500 can generate pseudocode or abstracted code that outlines the framework of the identified software design pattern in an informal language that corresponds to the programming style of the software developer. In some embodiments, a third AI model generates the suggested software design patterns.

In some embodiments, the method 500 generates one or more test cases that are based on a suggested software design pattern selected by the software developer. The test cases provide the user with performance information that allows the user to select an optimal software design pattern for a software program. The test cases can be designed in a functionality flow of a final system design, which enables the software developer to more efficiently identify a software design pattern that is best for implementing functionality in the software program.

Operation 508 displays the suggested software design pattern in the code editor to allow the software developer to incorporate the suggested software design pattern into the code editing input using the intelligent code editor. In some embodiments, the method 500 provides the suggested software design pattern in a user interface of the intelligent code editor via a pop-up dialog, pop-up window, or the like. Providing the suggested software design pattern in the user interface of the intelligent code editor allows the software developer to accept the suggested software design pattern and incorporate the suggested software design pattern into the source code of the software developer's project. In some embodiments, the method 500 can auto populate a suggested software design pattern into the software developer's source code when the suggested software design pattern is selected by the software developer.

In some embodiments, the method 500 receives, via the user interface of the intelligent code editor, an assistance request from the software developer that asks other software developers for help in understanding and/or modifying a software design pattern. In response to receiving the assistance request, the method 500 launches a shared development environment that is accessible to the other software developers via a collaborative development portal, and provides the software design pattern to the shared development environment. The other software developers can then access the shared development environment containing the software design pattern via respective instances of the code editor and provide the assistance requested. For example, the method 500 sends a connection request to a device hosting an instance of the intelligent code editor associated with an authorized software developer, where the connection request includes information that allows the authorized software developer to determine whether to accept the connection request. In some embodiments, the identities of authorized software developers can be anonymized in the shared development environment.

The method 500 described above can be implemented as computer code (e.g., the intelligent code editor 650 in FIG. 6) and performed by a computer (e.g., computer 601 in FIG. 6), performed in a cloud environment (e.g., clouds 606 or 605 in FIG. 6), and/or generally can be implemented in fixed-functionality hardware, configurable logic, logic instructions, etc., or any combination thereof. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as computer code for an intelligent code editor 650. In addition to the computer code for the intelligent code editor 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and intelligent code editor 650, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The computer readable program instructions, and associated data, are accessed by processor set 610 to control and direct performance of the inventive methods. In computing environment 600, at least some of the instructions for performing the inventive methods may be stored in the intelligent code editor 650 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The intelligent code editor 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
analyzing source code samples associated with a software developer to determine coding techniques utilized by the software developer;
monitoring code editing input received by an intelligent code editor to identify a software design pattern, wherein the code editing input is associated with the software developer;
generating a suggested software design pattern that is based on the software design pattern identified in the code editing input and the coding techniques of the software developer; and
displaying the suggested software design pattern in the intelligent code editor to allow the suggested software design pattern to be incorporated into the code editing input using the intelligent code editor.

2. The computer-implemented method of claim 1, wherein monitoring the code editing input further comprises:
analyzing the code editing input using a first artificial intelligence (AI) model to identify the software design pattern in the code editing input.

3. The computer-implemented method of claim 1, wherein analyzing the source code samples to determine the coding techniques utilized by the software developer further comprises:
identifying software design patterns that the software developer has utilized previously to implement functionality in existing software programs; and
determining that the software design pattern identified in the code editing input corresponds to one of the software design patterns previously utilized by the software developer.

4. The computer-implemented method of claim 1, wherein generating the suggested software design pattern further comprises:
generating the suggested software design pattern to adhere to a system requirement of a software program associated with the code editing input.

5. The computer-implemented method of claim 1, further comprising generating one or more test cases that are based on the suggested software design pattern in response to user-selection of the suggested software design pattern.

6. The computer-implemented method of claim 1, further comprising:
receiving, via the intelligent code editor, an assistance request from the software developer, wherein the assistance request is associated with the code editing input that correlates to the software design pattern;
generating a shared development environment that is accessible to authorized software developers via a collaborative development portal; and
providing the code editing input to the shared development environment to allow the authorized software developers to access the code editing input via respective instances of the intelligent code editor that connect to the collaborative development portal.

7. The computer-implemented method of claim 6, further comprising anonymizing the authorized software developers in the shared development environment.

8. The computer-implemented method of claim 4, further comprising sending a connection request to an instance of the intelligent code editor associated with an authorized software developer, wherein the connection request includes information to allow the authorized software developer to determine whether to accept the connection request.

9. A system comprising:
one or more computer readable storage media storing program instructions and one or more processors which, in response to executing the program instructions, are configured to:
analyze source code samples associated with a software developer to determine coding techniques utilized by the software developer;
monitor code editing input received by an intelligent code editor to identify a software design pattern, wherein the code editing input is associated with the software developer;
generate a suggested software design pattern that is based on the software design pattern identified in the code editing input and the coding techniques of the software developer; and
display the suggested software design pattern in the intelligent code editor to allow the suggested software design pattern to be incorporated into the code editing input using the intelligent code editor.

10. The system of claim 9, wherein the program instructions configured to cause the one or more processors to analyze the source code samples to determine the coding techniques utilized by the software developer are further configured to cause the one or more processors to:
identify software design patterns that the software developer has utilized previously to implement functionality in existing software programs; and
determine that the software design pattern identified in the code editing input corresponds to one of the software design patterns previously utilized by the software developer.

11. The system of claim 9, wherein the program instructions configured to cause the one or more processors to generate the suggested software design pattern are further configured to cause the one or more processors to:
generate the suggested software design pattern to adhere to a system requirement of a software program associated with the code editing input.

12. The system of claim 9, wherein the program instructions are further configured to cause the one or more processors to generate one or more test cases that are based on the suggested software design pattern in response to user-selection of the suggested software design pattern.

13. The system of claim 9, wherein the program instructions are further configured to cause the one or more processors to:
receive, via the intelligent code editor, an assistance request from the software developer, wherein the assistance request is associated with the code editing input that correlates to the software design pattern;
generate a shared development environment that is accessible to authorized software developers via a collaborative development portal; and
provide the code editing input to the shared development environment to allow the authorized software developers to access the code editing input via respective instances of the intelligent code editor that connect to the collaborative development portal.

14. The system of claim 9, wherein the program instructions are further configured to cause the one or more processors to send a connection request to an instance of the intelligent code editor associated with an authorized software developer, wherein the connection request includes information to allow the authorized software developer to determine whether to accept the connection request.

15. A computer program product comprising:
one or more computer readable storage media, and program instructions collectively stored on the one or more computer readable storage media, the program instructions configured to cause one or more processors to:
analyze source code samples associated with a software developer to determine coding techniques utilized by the software developer;
monitor code editing input received by an intelligent code editor to identify a software design pattern, wherein the code editing input is associated with the software developer;
generate a suggested software design pattern that is based on the software design pattern identified in the code editing input and the coding techniques of the software developer; and
display the suggested software design pattern in the intelligent code editor to allow the suggested software design pattern to be incorporated into the code editing input using the intelligent code editor.

16. The computer program product of claim 15, wherein the program instructions configured to cause the one or more processors to analyze the source code samples to determine the coding techniques utilized by the software developer are further configured to cause the one or more processors to:
identify software design patterns that the software developer has utilized previously to implement functionality in existing software programs; and
determine that the software design pattern identified in the code editing input corresponds to one of the software design patterns previously utilized by the software developer.

17. The computer program product of claim 15, wherein the program instructions configured to cause the one or more processors to generate the suggested software design pattern are further configured to cause the one or more processors to:
generate the suggested software design pattern to adhere to a system requirement of a software program associated with the code editing input.

18. The computer program product of claim 15, wherein the program instructions are further configured to cause the one or more processors to generate one or more test cases that are based on the suggested software design pattern in response to user-selection of the suggested software design pattern.

19. The computer program product of claim 15, wherein the program instructions are further configured to cause the one or more processors to:
receive, via the intelligent code editor, an assistance request from the software developer, wherein the assistance request is associated with the code editing input that correlates to the software design pattern;
generate a shared development environment that is accessible to authorized software developers via a collaborative development portal; and
provide the code editing input to the shared development environment to allow the authorized software developers to access the code editing input via respective instances of the intelligent code editor that connect to the collaborative development portal.

20. The computer program product of claim 15, wherein the program instructions are further configured to cause the one or more processors to send a connection request to an instance of the intelligent code editor associated with an authorized software developer, wherein the connection request includes information to allow the authorized software developer to determine whether to accept the connection request.
